(19) United States
(12) Patent Application Publication
(10) Pub. No.: US 2021/0293270 A1
(43) Pub. Date: Sep. 23, 2021

(54) HINGE ASSEMBLY

(71) Applicant: Hewlett-Packard Development Company, L.P., Spring, TX (US)

(72) Inventors: Shuang-Kun Zhu, Shanghai (CN); Zhi Yuan Zhao, Shanghai (CN); Ji-Wei Zhang, Shanghai (CN)

(73) Assignee: Hewlett-Packard Development Company, L.P., Spring, TX (US)

(21) Appl. No.: 17/262,369

(22) PCT Filed: Nov. 2, 2018
(86) PCT No.: PCT/CN2018/113596

§ 371 Date: Jan. 22, 2021

(51) Int. Cl. F16C 11/04

(52) U.S. Cl. CPC F16C 11/04; E05D 11/087; E05Y 2201/216

(57) ABSTRACT

A hinge assembly comprise a hinge shaft (102) and a friction gear (108) located around the hinge shaft (102), wherein the friction gear (108) is to rotate around the hinge shaft (102) to create a friction force between the friction gear (108), a washer (106) and a retaining ring (114), generating a damper responsive to closing of a component coupled to the hinge assembly. A hinging method is disclosed.

### BACKGROUND

A hinge is a mechanical bearing that connects two objects, that may allow a limited angle of rotation between the two objects. Two objects connected by a hinge may rotate relative to each other about a fixed axis of rotation with other translations or rotations being prevented resulting in the hinge has one degree of freedom. Hinges may be made of flexible material or of moving components.

### BRIEF DESCRIPTION OF THE DRAWINGS

FIG. 1 illustrates a diagram of an example hinge assembly according to the present disclosure.

FIG. 2 illustrates a diagram of an example hinge assembly and printing device cover according to the present disclosure.

FIG. 3 illustrates a diagram of an example hinge assembly coupled to cover of a printing device according to the present disclosure.

FIG. 4 illustrates another diagram of an example hinge assembly coupled to cover of a printing device according to the present disclosure.

FIG. 5 illustrates a diagram of an example hinge assembly coupled to a cover of a printing device during closing of a component coupled to the hinge assembly according to the present disclosure.

FIG. 6 illustrates another diagram of an example hinge assembly coupled to a cover of a printing device according to the present disclosure.

FIG. 7 illustrates a diagram of an example hinge assembly coupled to a cover of a printing device during opening of a component coupled to the hinge assembly according to the present disclosure.

FIG. 8 illustrates a diagram of an example hinging method according to the present disclosure.

### DETAILED DESCRIPTION

Hinging assemblies include components that are part of a hinge that work together to make the hinge function. For instance, in a barrel hinge, the hinging assembly includes a section barrel secured by a pivot. The barrel component has a hollow cylinder-shaped section where the rotational bearing force is applied to the pivot. These different components (e.g., barrel, pivot, etc.) make up the hinge assembly and work together to make the hinge function.

A hinge assembly may have an associated damper. A damper deadens, restrains, or depresses. For instance, a friction force may be a damper on a hinge assembly that causes resistance when opening or closing the hinge assembly. Printing devices (e.g., printers, scanners, copy machines, multi-functional printers, etc.) may use hinging assemblies to couple different components (e.g., a control panel (CP) to the printing device) allowing for movement between the different components. As used herein, coupling includes directly or indirectly connecting components. For instance, a printing device may be coupled to a hinging assembly, and the hinging assembly may be coupled to a CP. In the same example, the printing device is coupled to the CP (e.g., indirectly via the hinging assembly).

In other hinge assembly approaches, damper is generated when opening and closing a component coupled to the hinging assembly. In such examples, when a gear of the hinge assembly rotates, a friction force between the gear and a washer generate a damper. If the damper is above a desired threshold, an operation force for opening the component is increased, resulting in poor user experience (e.g., heavy and/or difficult to lift and/or open a component). If the damper is below a desired threshold, the damper is decreased, and the component may not have a retaining force (e.g., the component may fall and/or collapse).

In contrast, examples of the present disclosure use a hinge assembly including a ratchet structure (e.g., a friction gear/clutch ring combination) to create a unidirectional damper. For instance, when closing the component, the ratchet structure engages, and the friction gear is actuated. A friction force between the friction gear and a spring of the hinge assembly generates a damper. The friction force can also provide a retaining force for the component in an operating position. For instance, a component does not fall and/or collapse during operating because of the retaining force.

In some examples, the component is a CP of a printing device. When opening the CP, the ratchet structure is detached, and the friction gear is not actuated. In this instance, the CP can be moved freely (e.g., without damper). For instance, a user may open the CP of a printing device by pulling the CP away from the printing device without a damper (or with a damper below a particular threshold). When released, the CP changes to a closing action, and the damper is generated. The damper can act as a retaining force, so a user can view the CP without it fall or collapsing back to the printing device. The user can also adjust the angle of the CP, and the closing damper can hold that angle in place.

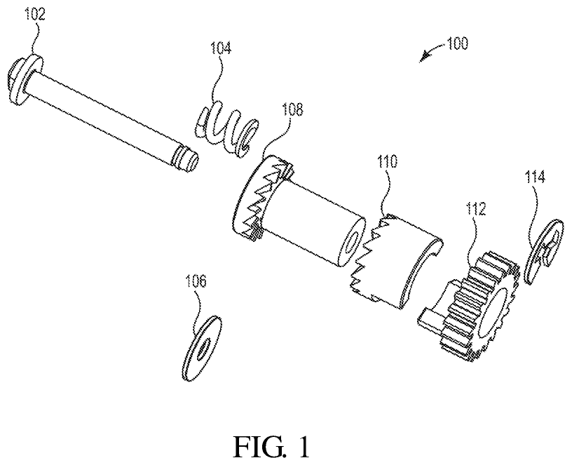

The figures herein follow a numbering convention in which the first digit corresponds to the drawing figure number and the remaining digits identify an element or component in the drawing. For example, reference numeral 102 refers to element “02” in FIG. 1 and an analogous element may be identified by reference numeral 302 in FIG. 3. Elements shown in the various figures herein can be added, exchanged, and/or eliminated so as to provide a number of additional examples of the disclosure. In addition, the proportion and the relative scale of the elements provided in the figures are intended to illustrate the examples of the disclosure and should not be taken in a limiting sense.

FIG. 1 illustrates a diagram of an example hinge assembly 100 according to the present disclosure. Hinge assembly 100 includes a hinge shaft 102, which may be non-rotatable, a spring 104, a washer 106, a friction gear 108, a clutch ring 110, a drive gear 115, and a retaining ring (e.g., an E-ring) 114. Friction gear 108 and clutch ring 110 can create a ratchet structure allowing for damper during closing of a component, but not during opening of the component.

Friction gear 108 and clutch ring 110 can be located around hinge shaft 102, and as discussed further herein, friction gear 108 can rotate around hinge shaft 102 creating a friction force between friction gear 108, washer 106, and retaining ring 114 generating a damper and a retaining force for a component coupled to hinge assembly 100 responsive to closing of the component. For instance, closing a CP coupled to a printing device using hinge assembly 100 may generate a damper, allowing for adjustment of the CP (e.g., adjustment of an angle of the CP) and may generate a retaining force for the CP, preventing the CP from falling and/or collapsing towards the printing device.

In some instances, as discussed further herein, a damper is not present during opening of the component coupled to hinge assembly 100. For instance, when opening the component, drive gear 112 drives clutch ring 110 to disengage with friction gear 108. In such an example, friction gear 108 does not rotate, but remains still, and drive gear 112 rotates freely around friction gear 108.

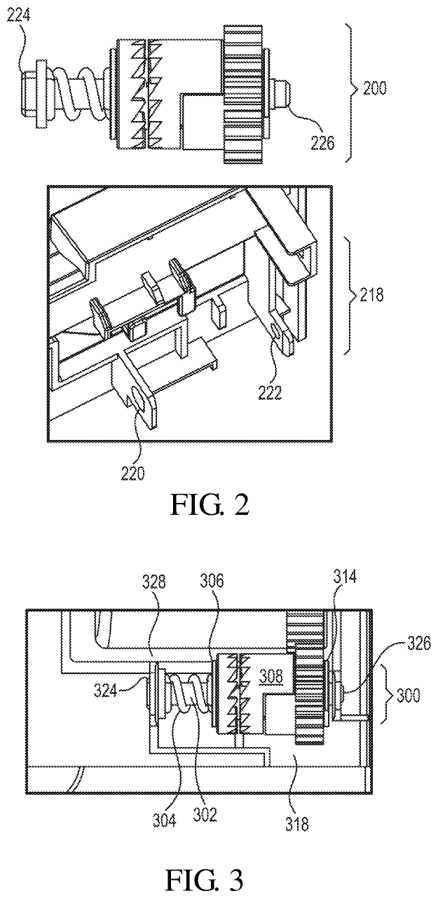

FIG. 2 illustrates a diagram of an example hinge assembly 200 and printing device cover 218 according to the present disclosure. Hinge assembly 200 can be coupled to a printing device, for instance via printing device cover 218, and a component (not illustrated in FIG. 2). The component, in some examples, is a CP. A CP, as used herein, is a component of the printing device that allows for viewing and changing settings of the printing device (e.g., print size, print numbers, color vs. black-and-white printing, etc.). The CP may be adjustable, via hinging assembly 200, for improved use and visibility for a user.

Printing device cover 218 (e.g., a printing device front cover) can include holes (e.g., holes 220 and 222) to receive hinge assembly 200. While two holes 220, 222 are illustrated in FIG. 2, more or fewer holes may be present for receiving hinge assembly 200, and/or another attachment method may be possible for coupling hinge assembly 200 to a printing device or other component coupled to hinge assembly 200. A first end 224 of hinge shaft 202 can be inserted into hole 220 of printing device cover 218, and a second end 226 of hinge shaft 202 can be inserted into hole 222. The holes, in some examples, can be shaped to fit a specific shape of hinge shaft 202 and/or its ends 224, 226. For instance, hole 220 may be D-shaped to receive a D-shaped end 224. The D-shape can constrain rotation of hinge shaft 202.

FIG. 3 illustrates a diagram of an example hinge assembly 300 coupled to a printing device cover 318 according to the present disclosure. FIG. 3 illustrates friction gear 308 with clutch right 310 and drive gear 312 removed for purposes of viewing friction gear 308 during closing of a component 328 (e.g., a CP) coupled to hinge assembly 300. Friction gear 308 is pinched by spring 304, washer 306, and retaining ring 314. When friction gear 308 rotates around hinge shaft 302, there is a friction force between friction gear 308, washer 306, and retaining ring 314. This friction force can generate the damper when closing component 328 and can provide a retaining force for component 328.

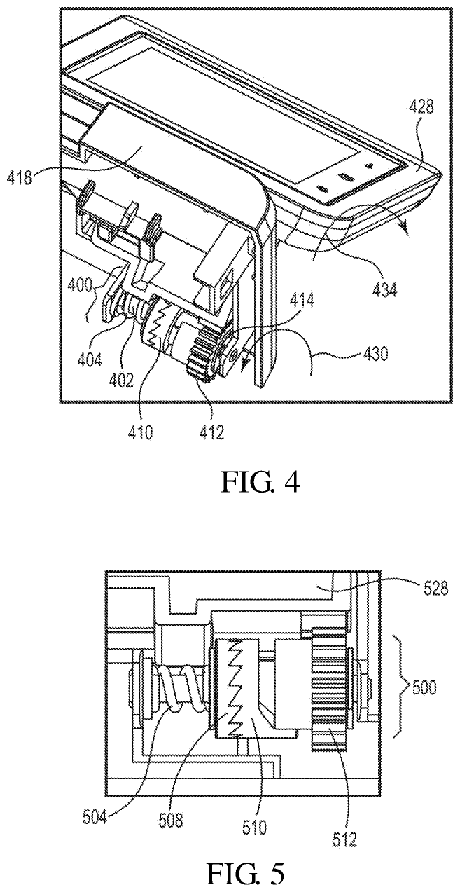

FIG. 4 illustrates another diagram of an example hinge assembly 400 coupled to a printing device cover 418 according to the present disclosure. The example illustrated in FIG. 4 can include printing device cover 418 (e.g., a printing device front cover) coupled to component 428 via hinge assembly 400. Component 428, in some examples, is a CP of the printing device, but may be a different component of the printing device in other examples. Component 428 can be adjusted via hinge assembly 400 (e.g., open, close, adjust angle, etc.). For instance, FIG. 4 illustrates closing of component 428. Arrow 434 represents closing component 428 (e.g., pressure applied to push component 428 towards printing device cover 418).

Hinge assembly 400 includes spring 404 and friction gear 408 located around hinge shaft 402. Hinge assembly 400 also includes clutch ring 410 and drive gear 412 located around friction gear 408. Responsive to a closing of component 428 coupled to hinge assembly 400, clutch ring 410 is driven to engage with friction gear 412 such that friction gear 408 rotates as drive gear 412 rotates (e.g., in the direction of arrow 430) and a friction force between friction gear 408 and spring 404 generates a damper and a retaining force for component 428.

Hinge assembly 400 can also include a washer (not visible in FIG. 4) located around hinge shaft 402 and between spring 404 and friction gear 408. Retaining ring 414 can be located around hinge shaft 402 adjacent to drive gear 412 to counteract a force of spring 404 in some instances.

FIG. 5 illustrates a diagram of an example hinge assembly 500 coupled to a printing device cover 518 during closing of a component 528 coupled to the hinge assembly 500 according to the present disclosure. When closing component 528, the ratchet structure engages, and friction gear 508 is actuated. A friction force between friction gear 508 and spring 504 generates a damper during ratcheting. The friction force can also provide a retaining force for component 528 in the operation position. The operation position can include a position in which a user can manipulate and/or view component 528. For instance, if component 528 is a CP, the operating position may be a position chosen by a user to view and/or manipulate the CP. The user may prefer a particular angle, and the damper allows for adjustment, while the retaining force keeps the CP at the particular angle without falling and/or collapsing of the CP.

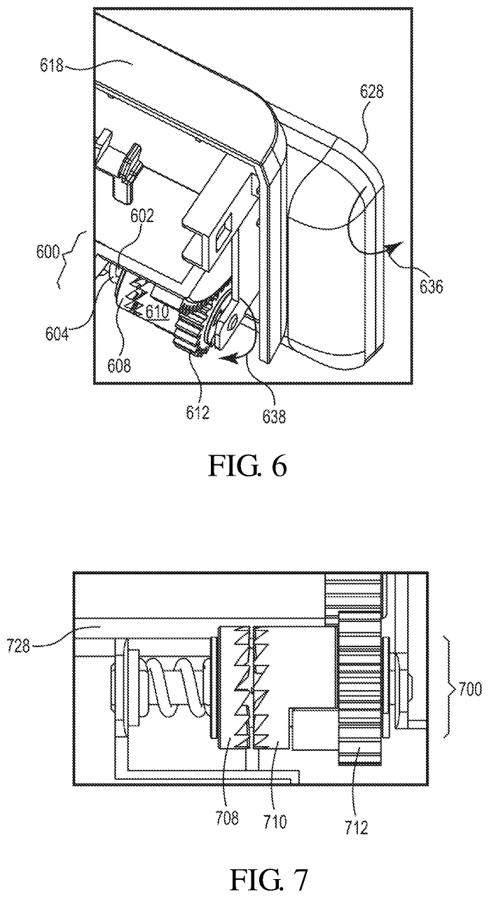

FIG. 6 illustrates another diagram of an example hinge assembly 600 coupled to printing device cover 618 according to the present disclosure. The example illustrated in FIG. 6 can include printing device cover 618 (e.g., a printing device front cover) coupled to component 628 via hinge assembly 600. Component 628, in some examples, is a CP of the printing device, but may be a different component of the printing device in other examples. Component 628 can be adjusted via hinge assembly 600 (e.g., open, close, adjust angle, etc.). For instance, FIG. 6 illustrates opening of component 628. Arrow 636 represents opening component 628 (e.g., pressure applied to pull component 628 away from printing device cover 618).

Hinge assembly 600 includes spring 604 and friction gear 608 located around hinge shaft 602. Hinge assembly 600 also includes clutch ring 610 and drive gear 612 located around friction gear 608. Responsive to opening of component 628, drive gear 612 drives clutch ring 610 to disengage with friction gear 608. In some examples, friction gear 608 does not rotate as drive gear 612 rotates around friction gear 608 (e.g., as illustrated by arrow 638).

Hinge assembly 600 can also include a washer (not visible in FIG. 6) located around hinge shaft 602 and between spring 604 and friction gear 608. Retaining ring 614 can be located around hinge shaft 602 adjacent to drive gear 612 to counteract a force of spring 604.

FIG. 7 illustrates a diagram of an example hinge assembly 700 coupled to a printing device cover 718 during opening of a component 728 coupled to the hinge assembly 700 according to the present disclosure. When opening component 728, the ratchet structure is detached, and friction gear 708 is not actuated. In such an example, component 728 can be moved freely. For instance, if component 728 is a CP coupled to a printing device via hinge assembly 700, the CP can be opened (e.g., pulled away from the printing device) with ease, as no damper (or a damper below a particular threshold) is present.

For instance, when opening component 728, drive gear 712 drives clutch ring 710 to disengage with friction gear 708. In such an example, friction gear 708 does not rotate, but remains still while drive gear 712 rotates freely around friction gear 708. Any damper in such an example is below a particular threshold. For instance, a damper is below a particular threshold when the damper includes unavoidable friction force (e.g., air resistance, unintended rubbing of components, etc.).

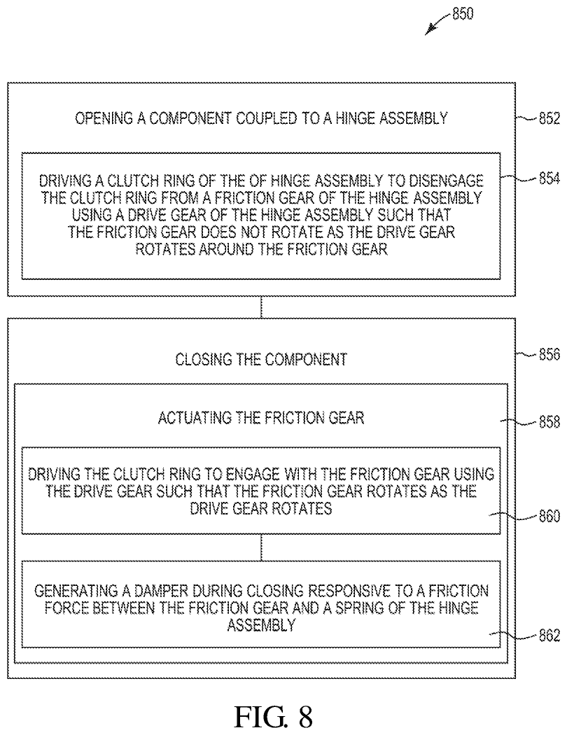

FIG. 8 illustrates a diagram of an example hinging method 850 according to the present disclosure. At 852, method 850 includes opening a component coupled to a hinge assembly. For instance, at 854, opening the component can include driving a clutch ring of the of hinge assembly to disengage the clutch ring from a friction gear of the hinge assembly using a drive gear of the hinge assembly such that the friction gear does not rotate as the drive gear rotates around the friction gear. In some examples, opening the component includes driving a clutch ring of the of hinge assembly to disengage the clutch ring from a friction gear such that a damper during opening is below a particular threshold damper. For instance, the component may move freely, resulting in the component opening with little to no resistance.

At 856, method 850 includes closing the component. For instance, at 858, closing the component can include actuating the friction gear. This can include, for instance at 860, driving the clutch ring to engage with the friction gear using the drive gear such that the friction gear rotates as the drive gear rotates. Actuating the friction gear, in some examples, can include a spring, a washer, and a retaining ring of the hinge assembly pinching the friction gear.

The friction force, in some instances, is created responsive to the friction gear rotating around a hinge shaft of the hinge assembly. The hinge shaft can be non-rotatable in some instances. The friction force, in some examples, can be created between the friction gear, the washer, and the retaining ring.

At 862, method 850 includes generating a damper during closing responsive to a friction force between the friction gear and a spring of the hinge assembly. The friction force, in some examples, can provide a retaining force for the component. For instance, the component can be adjusted to a desired angle, and the component will remain at that angle because of the retaining force until acted upon again.

As used herein, the designator “n”, particularly with respect to reference numerals in the drawings, indicates that a plurality of the particular feature so designated can be included with examples of the disclosure. The designators can represent the same or different numbers of the particular features. Further, as used herein, “a plurality of” an element and/or feature can refer to more than one of such elements and/or features.

In the foregoing detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

1. A hinge assembly, comprising:
a hinge shaft; and
a friction gear located around the hinge shaft, wherein the friction gear is to rotate around the hinge shaft creating a friction force between the friction gear, a washer, and a retaining ring generating a damper responsive to closing of a component coupled to the hinge assembly.

2. The hinge assembly of claim 1, further comprising a clutch ring located around the friction gear.

3. The hinge assembly of claim 1, wherein the hinge shaft is non-rotatable.

4. The hinge assembly of claim 1, wherein the friction force provides a retaining force for the component.

5. The hinge assembly of claim 1, wherein the component is a control panel, and wherein the hinge assembly couples the control panel to a printing device.

6. A hinge assembly, comprising:
a hinge shaft;
a spring located around the hinge shaft;
a friction gear located around the hinge shaft;
a clutch ring located around the friction gear; and
a drive gear located around the friction gear to, responsive to a closing of a component coupled to the hinge assembly, drive the clutch ring to engage with the friction gear such that:
the friction gear rotates as the drive gear rotates; and
a friction force between the friction gear and the spring generates a damper and a retaining force for the component.

7. The hinge assembly of claim 6, further comprising a washer located around the hinge shaft and between the spring and the friction gear.

8. The hinge assembly of claim 6, further comprising a retaining ring located around the hinge shaft to counteract a force of the spring.

9. The hinge assembly of claim 6, wherein the component is a control panel, and the hinge assembly couples a printing device to the control panel such that the control panel can be adjusted via the hinge assembly.

10. The hinge assembly of claim 6, further comprising the drive gear to, responsive to opening of the component, drive the clutch ring to disengage with the friction gear.

11. A hinging method, comprising:
opening a component coupled to a hinge assembly, comprising:
driving a clutch ring of the of hinge assembly to disengage the clutch ring from a friction gear of the hinge assembly using a drive gear of the hinge assembly such that the friction gear does not rotate as the drive gear rotates around the friction gear; and
closing the component, comprising:
actuating the friction gear, comprising:
driving the clutch ring to engage with the friction gear using the drive gear such that the friction gear rotates as the drive gear rotates; and
generating a damper during closing responsive to a friction force between the friction gear and a spring of the hinge assembly.

12. The method of claim 11, wherein actuating the friction gear further comprises a spring, a washer, and a retaining ring of the hinge assembly pinching the friction gear.

13. The method of claim 11, wherein actuating the friction gear further comprises creating the friction force responsive to the friction gear rotating around a hinge shaft of the hinge assembly, wherein the hinge shaft is non-rotatable.

14. The method of claim 13, wherein creating the friction force further comprises creating the friction force between the friction gear, the washer, and the retaining ring.

15. The method of claim 11, wherein opening the component further comprises driving a clutch ring of the of hinge assembly to disengage the clutch ring from a friction gear such that a damper during opening is below a particular threshold damper.
